(19) United States
(12) Patent Application Publication
(10) Pub. No.: US 2011/0283573 A1
(43) Pub. Date: Nov. 24, 2011

(54) DISPLAY CARD

(76) Inventor: Robert P. Sparkowski, Schaumburg, IL (US)

(21) Appl. No.: 13/111,457

(22) Filed: May 19, 2011

Related U.S. Application Data
(60) Provisional application No. 61/346,342, filed on May 19, 2010.

(51) Int. Cl. G09F 1/00

(52) U.S. Cl. 40/124.04; 40/124.01

(57) ABSTRACT

A display card for attachment to a shelving system. The display card comprises a display panel including a front surface, a rear panel connected to the display panel, a base panel extending from the rear panel, and a lip extending from the display panel, wherein the base panel and the lip include a plurality of openings for attaching the display card to the shelving system, and wherein the display card is constructed from a one piece blank.

The present patent application claims priority to U.S. Provisional Application No. 61/346,342, filed on May 19, 2010, the content of which is hereby incorporated by reference.

### BACKGROUND

The present invention generally relates to display cards that include various indicia printed on the card, where the cards duplicate the appearance of a particular product and are placed on shelving systems in different types of stores.

Grocery stores, convenience stores, gas stations and the like (“product sellers”) use various shelving systems to store and display different items and products that are offered to a customer. Shelving systems are available in a wide variety of shapes and configurations. Some shelving systems are permanently coupled to walls or other structures and other shelving systems are freestanding and are supported by the ground or dedicated base structures.

Product sellers generally like to keep fully stocked shelves at all times. Very often, however, this is not possible since many products are being sold daily and a seller may not have the necessary quantity of a particular product in inventory to fully stock a depleted shelf. In addition, a product seller may sell its entire stock of a particular product, which will leave the designated shelf empty and may create negative impressions in some customers looking for that specific product. Because the overall store appearance is very important for product sellers, in the depleted stock situations a product seller would like to avoid having shelves that look completely or partially empty. Based upon these and other industry needs, a display card that emulates the image of a particular product and is placed on the shelf with any remaining product would be useful.

### SUMMARY

Thus, there is a need for a display card used for displaying products' indicia, where the card can be placed on wire shelving systems in front, behind, or in the midst of a product. The display card is constructed from a one piece blank that can be folded into a “tent” shape and the indicia printed on the card emulates a product placed on the shelving system. Various connecting mechanisms are used to securely attach the display card to a shelving system.

In one embodiment, the invention provides a display card for attachment to a shelving system. The display card comprises a display panel including a front surface, a rear panel connected to the display panel, a base panel extending from the rear panel, and a lip extending from the display panel, wherein the base panel and the lip include a plurality of openings for attaching the display card to the shelving system, and wherein the display card is constructed from a one piece blank.

In another embodiment, the invention provides a shelving system including a wire shelf having a support surface and a display card for attachment to the wire shelf, the display card constructed from a one piece blank. The display card includes a display panel, a rear panel connected to the display panel, a base panel extending from the rear panel and positioned on the support surface, and a lip extending from the display panel and mated to at least a portion of the base panel, wherein the base panel and the lip include a plurality of openings for attaching the display card to the wire shelf.

In yet another embodiment, the invention provides a shelving system. The shelving system includes a wire shelf having a support surface and a display card for attachment to the wire shelf, the display card constructed from a one piece blank. The display card includes a display panel, a rear panel connected to the display panel, a base panel extending from the rear panel and positioned on the support surface, the base panel including a plurality of openings, and a lip extending from the display panel and mated to at least a portion of the base panel, the lip including a plurality of openings aligned with the openings of the base panel. The shelving system further includes a plurality of supporting mechanisms extending through the openings in the base panel and the lip and engaging the wire shelf for securing the display card to the wire shelf, wherein the lip connects to at least a portion of the base panel, and wherein the display panel includes indicia emulating a packaging design of a product.

Other aspects of the invention will become apparent by consideration of the detailed description and accompanying drawings.

### BRIEF DESCRIPTION OF THE DRAWINGS

FIG. 1 is a perspective view of one embodiment of a display card in assembled position.

FIG. 2 is a top plan view of the blank from which the display card of FIG. 1 is formed.

FIG. 3 is a side view of the display card of FIG. 1.

FIG. 4 is a perspective view of the display card of FIG. 1 in relation to a wire shelf.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, in describing the preferred embodiments, specific terminology will be resorted to for the sake of clarity. It is to be understood that each specific term includes all technical equivalents which operate in a similar manner to accomplish a similar purpose.

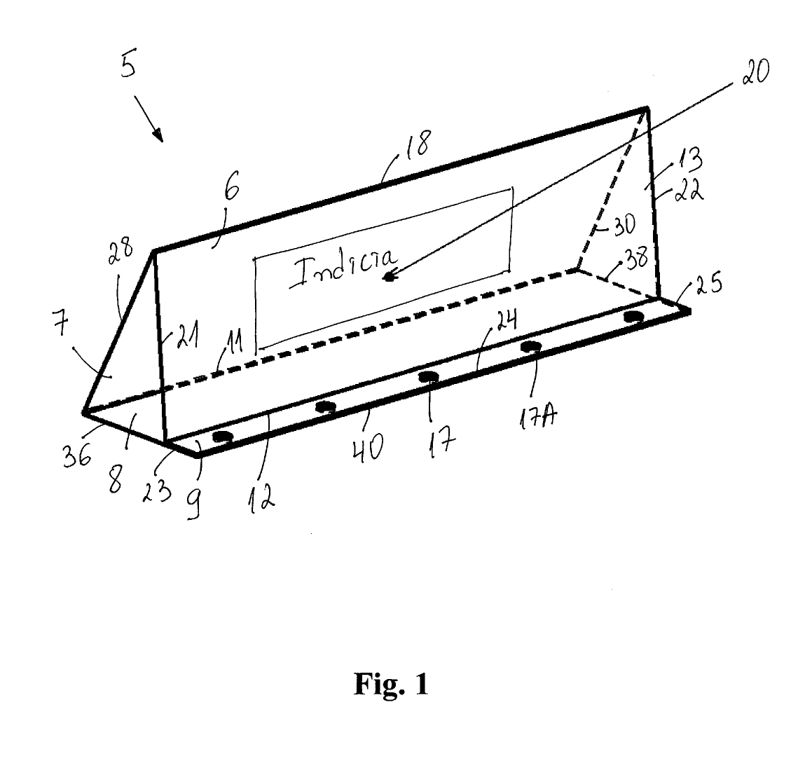

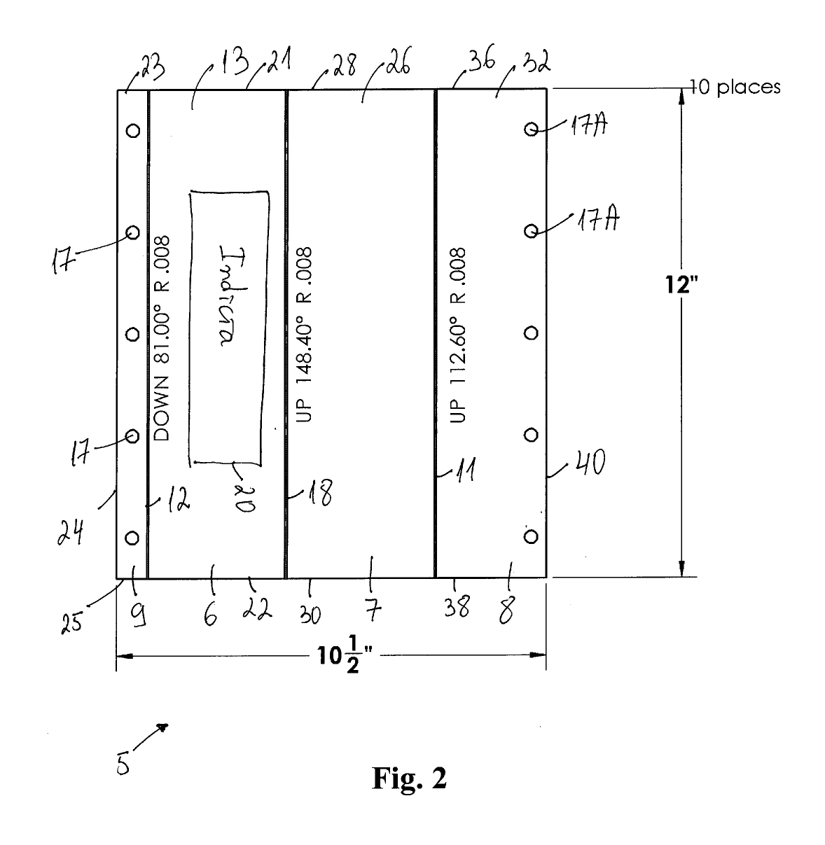

FIG. 1 illustrates a display card 5 according to one embodiment of the present invention. The illustrated display card 5 is generally constructed of a one piece blank (shown in FIG. 2). Various indicia are printed or attached to the blank and the blank is then die cut and folded once into a “tent” shape display card. Generally, the indicia printed on the display card reproduces or emulates the packaging design of a particular product, so that to a casual observer, the card appears to be the product or products to be displayed on the shelf. The display card 5 having indicia can be placed on wire shelving systems in front, behind or in the midst of the product with its packaging design on the display card. For the purposes of description, the term “proximal” means the portion of the display card 5 or of the shelf to which it is mounted nearest to a viewer when the display card is mounted on a shelf, whereas the “distal” means opposite the proximal side.

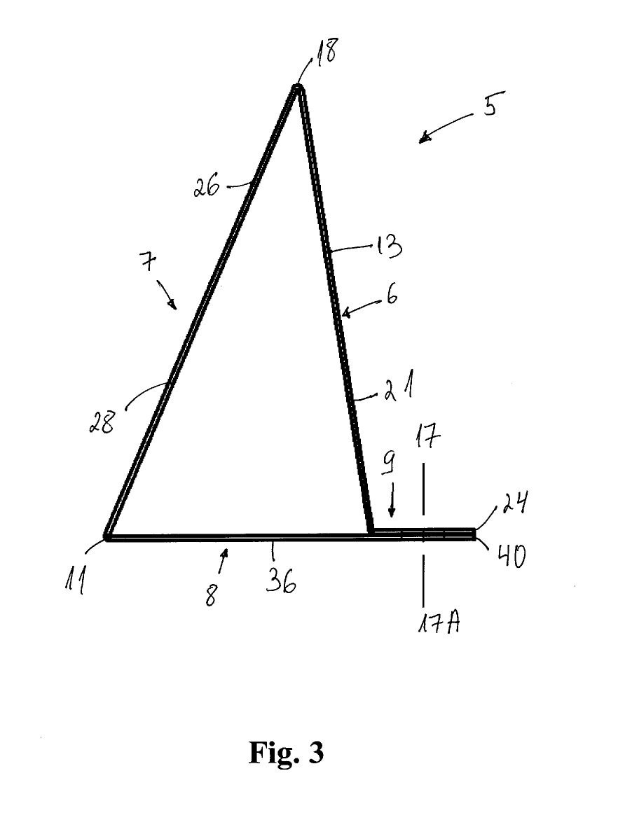

FIGS. 1-3 illustrate the general components of the display card 5. The display card 5 includes a display panel 6, a rear panel 7, a base panel 8, and a lip 9. Fold line 18 connects the display panel 6 with the rear panel 7. The base panel 8 extends from the rear panel 7 and these two panels are connected via fold line 11. The lip 9 extends from the display panel 6 and is connected to the display panel 6 via a fold line 12. The display card 5 also includes indicia 20 generally positioned on the display panel 6. The base panel 8 and the lip 9 further include a number of openings 17 and 17A.

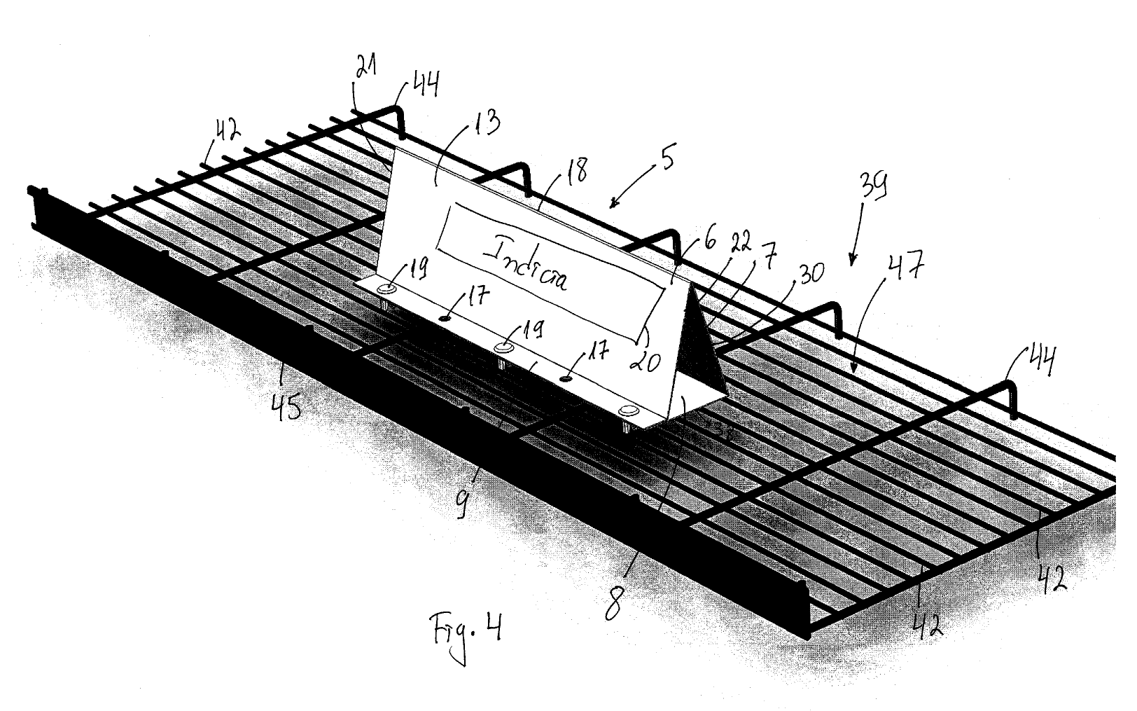

In the embodiment shown in FIG. 2, the blank has generally a rectangular form and the display panel, 6 the rear panel 7, the base panel 8, and the lip 9 have an equal length. In alternative embodiments, the blank can consequently the display card can have other shapes and forms. The display card 5 can be constructed of any material that can be easily printed on, cut, and folded into the desired “tent” shape as shown in the illustrated embodiment. In the illustrated embodiment, the display card 5 is attached to the shelving system via supporting mechanism(s) 19 (e.g., fasteners shown in FIG. 4) inserted in the openings 17 and 17A. In alternative embodiment, the display card 5 can be attached to a shelving system via wires, clips, different types of fasteners, or other suitable means. In one embodiment, the display card is constructed of cardboard material. In alternative embodiments, the display card can be constructed of plastic, thin metal sheet, composite material, or other suitably rigid but foldable material.

FIG. 2 shows the display card 5 in an unfolded position. The display panel 6 of display card 5 includes a front surface 13 and a back surface 14 (not shown), a first edge 21, a second edge 22 parallel to the first edge 21, and parallel fold lines 12 and 18 connecting the display panel 6 to the lip 9 and the rear panel 7 respectively. The fold line 18 enables the display panel 6 to be folded relative to the rear panel 7 to form the “tent” shape of the display card 5. The fold line 12 enables the lip 9 to be folded relative to the display panel 6 and to position the lip 9 parallel to the base panel 8. The display panel 6 has generally a rectangular shape. In some alternative embodiments, the display panel 6 can have different shapes.

The lip 9 extends from the display panel 6 via the fold line 12. The lip includes a first edge 23, a second edge 25 parallel to the first edge 23, and a third edge 24 parallel to the fold line 12. In some embodiments, the width of the lip 9 is smaller than the width of the display panel 6. The lip 9 further includes a number (e.g., five as shown) of openings 17. In some embodiments, the openings 17 are positioned at the center of the lip 9. In other embodiments, the openings 17 are positioned near the third edge 24 of the lip 9.

The rear panel 7 extends from the display panel 6 and is connected to the display panel 6 via the fold line 18. The rear panel 7 includes a front surface 26, a back surface 27 (not shown), a first edge 28, a second edge 30 parallel to the first edge 28, and a fold line 11 parallel to the fold line 18. When the display card 5 is in assembled position, the display panel 6 is positioned at an angle with respect to the rear panel 7. The angle between the display panel 6 and the rear panel 7 varies depending on the form and size of the panels 6 and 7. In the illustrated embodiment, the rear panel 7 is generally blank, i.e. it does not include any indicia. In alternative embodiments, however, the front surface 26 or the back surface 27 of the rear panel 7 can include indicia similar to or different from the indicia on display panel 6. In that way, the display card 5 can be rotated and folded in different ways to present either the display panel 6 or the rear panel 7 to a viewer.

The base panel 8 extends from the rear panel 7 and is connected to the rear panel via the fold line 11. The base panel 8 includes a top surface 32, a bottom surface 34 (not shown), a first edge 36, a second edge 38 parallel to the first edge 36, and a third edge 40 parallel to the fold line 11. The base panel 8 further includes a number (e.g., five as shown) of openings 17A. In some embodiments, the openings 17A are positioned near the third edge 40 of the base panel 8. When the display card 5 is in assembled position, the bottom surface 34 of the base panel 8 rests on to the wire shelve (see FIG. 4). Further, at least a portion of the top surface 32 of the base panel 8 is parallel and connects with the lip 9. In one embodiment, the openings 17A of the base panel 8 are aligned with the openings 17 of the lip 9. In other words, the openings 17A of the base panel 8 are positioned symmetrically parallel to the openings 17 of the lip 9. As shown in FIG. 4, the display card 5 is attached to a wire shelve of a shelving system by using supporting mechanisms (e.g., fasteners) inserted through the openings 17 and 17A of the base panel 8 and the lip 9.

The indicia 20 are positioned on the front surface 13 of the display panel 6 so that a customer viewing the shelf with the display card 5 can easily see the indicia 20. The indicia 20 can cover the entire front surface 13 of the display panel 6 or the indicia can only cover parts of the front surface 13. In an alternative embodiment, the same or different indicia from the indicia on the front surface 13 indicia can be on the back surface 14 of the display panel 6 and the display card 5 can be folded in a direction opposite to the direction shown in FIG. 1 so that back surface 14 faces a customer viewing the shelf.

The indicia 20 can be customized and can include any type of indicia that a user desires to print on the display card. The indicia can be printed in color or in black and white, and can include or replicate the packaging design of a product. The indicia 20 can be printed directly on or attached to the display card in various ways. In one embodiment, the indicia 20 can be printed on a sticker (not shown) and the sticker can be attached to the display card 5. In an alternative embodiment (when the display card is made from metal), the indicia 20 can be printed on a magnet (not shown) and the magnet can consequently attach to the front surface 13 of the display panel 6. In a further embodiment, the indicia 20 can be printed on a paper and can be attached to the display panel via glue, clips, pins, or other suitable means.

As illustrated in FIGS. 1-3, the display card 5 includes openings 17 and 17 A that are used to attach the display card 5 to a shelving system. As mentioned above, the openings 17 in the lip 9 are aligned with the openings 17A of the base panel 8. In the illustrated embodiment, the lip 9 and the base panel 8 include 5 openings that have circular cross-section. In alternative embodiments, the display card 5 can have more or less openings 17 that are located in different portions of the of the lip 9 and the base panel 8. Further, the openings of the display card can have different cross-sections. The openings 17 and 17A are custom die cut to their particular shape and to a width slightly larger than the diameter of a wire comprising the wire shelf, so that a supporting mechanism 19 extending downwardly through the openings frictionally engages a wire of the shelf. In yet another alternative embodiment, the display card can be constructed without openings 17 (when the shelving system comprises one or more solid pieces of material) and the display card can be attached to a shelving system via different types of fasteners, clips, by gluing, or using other reasonable means.

FIG. 4 illustrates a perspective view of the display card 5 that is placed in a position to be attached to a shelf 39 of a shelving system. The illustrated shelf 39 is generally rectangular, but various shelf shapes may be used. The shelf 39 is defined by a plurality of wire members including a plurality of first wire members 42 and several second wire members 44. The first wire members 42 are spaced apart from and extend substantially parallel to one another. Together the first wire members 42 define an upwardly facing support surface 47 of the shelf 39. The second wire members 44 are coupled to the first wire members 42 on a side opposite the support surface 47. The second wire members 44 are spaced apart from and extend substantially parallel to one another and perpendicular to the first wire members 42. The opposing ends of the first wire members 42 join together with certain of the second wire members 44 and define the left and right edges of the shelf 39. The front ends of the second wire members 44 are attached to a support 45. Although the illustrated construction includes a shelf 39 formed of individual wires, the shelf could also be formed of, for example, one or more pieces of solid metal, wood, and/or plastic.

When the assembled display card 5 is positioned on the shelf 39, the bottom surface 34 of the base panel 8 rests on the support surface 47 of the shelf 39, such as the base panel 8 is parallel to the support surface 47. The lip 9 is parallel and connected to at least a portion of the base panel 8 (e.g., the portion of the base panel 8 near the third edge 40). The openings 17 of the lip 9 are symmetrically parallel to the openings 17A of the base panel 8.

In one embodiment, the display card 5 is attached to the shelf 39 by first aligning the openings 17 and 17A of the display card 5 with one of the first wire member 42. Then, the supporting mechanisms 19 (e.g., fasteners, clips, etc.) are inserted through the openings 17 and 17A to engage the first wire members 42. That way, the display card 5 is attached to the first members 42 and is firmly secured to the shelf 39. As discussed previously, the openings 17 and 17A are die cut previously for a specific wire shelf configuration and size. In other embodiments, the supporting mechanisms 19 engage with the one or more of the second wire member 44. In yet another embodiment, the supporting mechanisms 19 engage with the one of the first wire members 42 and one or more of the second wire member 44 simultaneously. In some embodiments, other supporting mechanisms 19 for engaging the display card 5 to the shelf 39 can be used. In the embodiment illustrated in FIG. 4, the supporting mechanisms 19 engage with this particular type of wire shelving. In alternative embodiment, the openings 17 and 17A can be precut differently so different supporting mechanisms 19 fit with and engage different types of shelving.

As shown in FIG. 4, the display card 5 includes indicia that imitates the packaging design of a particular product (not shown). After the indicia is printed or otherwise attached to the display card 5, the display card 5 is placed on a wire shelving system in a manner described in the preceding paragraph. The display card 5 can be used in several different ways. For example, if a shelf can hold ten products but a store owner wants only to place five products at the front portion of the shelf, the display card 5 can be positioned behind the last of these products so the products lean on the display card 5. That way, to a customer, the shelf will appear completely stocked with products. In addition, when a shelf is depleted of a product one or several display cards 5 can be placed at the front of the shelf so that it appears full and attractive to a customer. Further, the display card 5 can be also used when the store owner wants to communicate that this particular product is available but currently out of stock. In this case, the indicia printed on the display card may read “Available but out of stock.” In an alternative embodiment, the display card 5 can be used for advertising particular products.

Because the display card 5 is constructed from a one piece blank and can be assembled without any adhesive, multiple display cards 5, in their unconstructed state, can stack in a stable manner. As discussed previously, the display cards can include indicia that is printed on the cards in advance or can be delivered blank and the user can apply the desired indicia (by printing, gluing it, or using a sticker). Once stacked, the display cards 5 generally can be easily moved, shipped and stored. By being stackable, the display cards can be compactly, securely, and neatly placed within a shipping container. In this way, shipping costs for a given number of display cards may be reduced, thereby reducing overall costs for the display cards.

What is claimed is:

1. A display card for attachment to a shelving system, the display card comprising:
a display panel including a front surface;
a rear panel connected to the display panel;
a base panel extending from the rear panel; and
a lip extending from the display panel,
wherein the base panel and the lip include a plurality of openings for attaching the display card to the shelving system, and wherein the display card is constructed from a one piece blank.

2. The display card of claim 1, wherein the lip is mated to at least a portion of the base panel.

3. The display card of claim 1, further comprising indicia positioned on the display panel, the indicia emulating a packaging design of a product.

4. The display card of claim 3, wherein the indicia covers the entire front surface of the display panel.

5. The display card of claim 3, wherein the indicia is printed directly on the display panel.

6. The display card of claim 3, wherein the indicia is removably attached to the display panel.

7. The display card of claim 3, wherein the indicia is printed on a magnet attached to the display panel.

8. The display card of claim 1, wherein the display panel is positioned at an angle with respect to the rear panel.

9. The display card of claim 1, wherein the openings in the base panel are aligned with the openings of the lip.

10. The display card of claim 1, wherein the display panel and the rear panel are connected by a fold line.

11. The display card of claim 1, wherein the display panel, the rear panel, the base panel, and the lip have an equal length.

12. A shelving system comprising:
a wire shelf having a support surface; and
a display card for attachment to the wire shelf, the display card constructed from a one piece blank and including
a display panel,
a rear panel connected to the display panel,
a base panel extending from the rear panel and positioned on the support surface, and
a lip extending from the display panel and mated to at least a portion of the base panel;
wherein the base panel and the lip include a plurality of openings for attaching the display card to the wire shelf.

13. The shelving system of claim 12, further comprising indicia positioned on the display panel, the indicia emulating a packaging design of a product.

14. The shelving system of claim 13, wherein the indicia covers the entire front surface of the display panel.

15. The shelving system of claim 13, wherein the indicia is printed directly on the display panel.

16. The shelving system of claim 13, wherein the indicia is removably attached to the display panel.

17. The shelving system of claim 13, wherein the indicia is printed on a magnet attached to the display panel.

18. The shelving system of claim 12, wherein the display panel is positioned at an angle with respect to the rear panel.

19. The shelving system of claim 12, further comprising fasteners extending through the openings in the base panel and the lip and engaging the wire shelf for securing the display card to the wire shelf.

20. A shelving system comprising:
a wire shelf having a support surface;
a display card for attachment to the wire shelf, the display card constructed from a one piece blank and including
a display panel,
a rear panel connected to the display panel,
a base panel extending from the rear panel and positioned on the support surface, the base panel including a plurality of openings, and
a lip extending from the display panel and mated to at least a portion of the base panel, the lip including a plurality of openings aligned with the openings of the base panel; and
a plurality of supporting mechanisms extending through the openings in the base panel and the lip and engaging the wire shelf for securing the display card to the wire shelf,
wherein the lip connects to at least a portion of the base panel, and
wherein the display panel includes indicia emulating a packaging design of a product.
